(19) United States
(12) Patent Application Publication
(10) Pub. No.: US 2003/0037984 A1
(43) Pub. Date: Feb. 27, 2003

(54) Front end loader multiple implement attachment apparatus

(76) Inventors: Mac E. McPherson, Jamestown, ND (US); Michael G. McPherson, Jamestown, ND (US); Gary A. Parkos, Browerville, MN (US); Roger D. Noska, Browerville, MN (US)

Correspondence Address: Curtis V. Harr, P. O. Box 2842, Fargo, ND, 58108-2842, US

(21) Appl. No.: 09/941,161

(22) Filed: Aug. 27, 2001

(51) Int. Cl. B62D 21/00

(52) U.S. Cl. 180/311; 180/291

(57) ABSTRACT

A frame apparatus that fits on the loader arms of a skid steer front end loader. This frame apparatus is supplied with a pair of castor wheels that may be used to lift the front wheels of the skid steer loader off of the ground allowing the skid steer to be used in situations where damage to the ground or sod needs to be minimized. The frame apparatus also serves as a platform upon which a plurality of implements can be employed to accomplish a variety of tasks that were previously beyond a skid steers ability due to its skidding wheel method of direction control and the damage that this may cause to fresh sod or loose ground.

### BACKGROUND OF THE INVENTION

The present invention relates to a front end loader attachment for utility tractors. More specifically, to a front end loader attachment having multi-purpose tools for use on skid steer loaders which employ the front arms and hydraulic system of the loader to lift the front wheels of the loader off of the ground to transfer the steering impetus from all four loader wheels to just the rear two.

Often times, industries such as factory yards, building sites and farms, utilize skid steer loaders. Skid steer loaders are small vehicles, typically having four wheels, which steer the vehicle by varying the speed of each set of wheels side to side. Due to the unique steering method, skid steers are easily maneuverable in tight quarters. Thus, skid steer loaders have proven to be very efficient and necessary in many work situations having limited space.

One area which has posed a problem to the use of skid steers is in the landscape or sod industry, such as golf courses or vineyards. By the very nature of the way skid steers turn, they may do a lot of damage to sod, sensitive grass or plants and thus, their use in certain areas has been limited by the turning feature which makes them so popular. Various solutions have been sought to allow skid steers to be used in varying conditions and to limit the amount of damage done to the ground by the skid turning motion of the wheels. One such patent is shown in the Gillette et al. U.S. Pat. No. 3,903.977 which discloses a device used on the rear of a skid steer in order to lift the rear wheels up and provide a caster wheel type system trailing the skid steer. This product requires the use of extra hydraulics to control the system in the rear as well as extending the distance or length of the overall unit and posing maintenance and damage problems. Another solution is shown in the Laurel U.S. Pat. No. 3,444,583 application which discloses the use of placing the caster wheels in the front on the loader attachment with a solid mounted implement. This again creates issues with lifting the front of the skid steer off the ground and controlling the mechanism at the same time without the use of extra hydraulics and may not be the most efficient way to perform this task.

Based upon the following disclosure, it can be seen that it would be advantageous to provide an attachment for skid steer loaders which may easily lift two of the wheels of the skid steer loader and allow for the use of front attachments such as rotary mowers, flail mowers, broadcast spreaders, sprayer tanks with booms, aerators, primary seeders, over seeders, slit seeders, leaf vacuums, turf paddle brushes, sod rollers, carrying racks and the like to be used in situations where the ground is particularly sensitive to damage by the skid steer when turning.

Further, it can be seen that it would be advantageous to do this in a way that would use the original equipment or OEM mounts of a skid steer to connect to the tool and allow for various attachments to be used with the tool, thus, keeping costs low when switching from attachment to attachment.

This problem has been solved by supplying a front attachment for skid steers using a pair of caster wheels and a pivoting attachment arm which may be used to mount to various attachments, thus minimizing the expense while maximizing the number of attachments which may be used by a given user and allowing the skid steer to be used in situations where the ground may be particularly sensitive to damage.

### SUMMARY OF THE INVENTION

It is the primary objective of the present invention to provide a manner of pivotally attaching a plurality of implements to the forward end of a typical front end loader in a manner that will allow the operator of the loader to easily select between a plurality of different implements attached to the loader.

It is also an objective of the present invention to provide a mechanism of pivotally mounting an implement to the forward end of a skid steer loader that will allow its ride height to be adjusted in relation to the surface over which the vehicle is traveling which will allow the invention to adapt to a variety of operating conditions.

It is another objective of the present invention to provide such a means of pivotally attaching implements to a front end loader in a manner which would allow the loader operator to use the loader's hydraulic system and front arms to transfer the weight off of the front wheels of the loader to the castor wheels of the invention.

It is an additional objective of the present invention to provide such a means of transferring the weight of the front of the loader to the invention's castor wheels which moves the steering control from all four wheels of the loader to only the rear wheels of the loader.

It is a further objective of the present invention to provide such a means of transferring the steering impetus of a skid steer loader from all four wheels to the rear two which will allow it to make sharp cornering maneuvers common to maintenance activities such as mowing on relatively delicate grass while minimizing damage to the surface.

It is a still further objective of the present invention to provide such a means of transferring the steering impetus of a skid steer loader from all four wheels to the rear two in a manner that does not require the redesign and costly modifications of the skid steer loader itself; a feature, due to its inexpensive nature, which will allow for the broader dissemination of the invention within the general skid steer loader using population.

These objectives are accomplished by the use of a plate with a frame apparatus that fits on the loader arms of a skid steer front end loader. This plate may be typically designed to meet the SAE specification J2513 which is the industry standard for skid steers being produced. The frame apparatus serves as a platform upon which a plurality of hydraulically or electrically driven implements can be employed to mow, brush, or scrape objects such as grassy fields, sidewalks or parking lots, and any one of a multitude of other objects that require similar maintenance or surface preparation.

The frame apparatus of the present invention also serves the primary purpose of providing a mechanism to the skid steer operator by which he can lift the front wheels of the loader off of the ground when the current invention is attached to it. This is accomplished by the use of the front end loader's arms and hydraulic system and a pair of castor wheels that are pivotally mounted on the present invention's frame in their horizontal aspect and solidly mounted in their vertical aspect. The castor wheels engage and run along the surface of the ground during the intended operation of the attached implement. With the castor 10 wheels engaged, the operator can activate the loader's hydraulic system to place downward pressure on the castor wheels through the forward arms. As this pressure is increased, the weight of the forward portion of the front end skid steer loader is distributed between its rear wheels and the castor wheels of the present invention. These castor wheels may be typically 20 inches in diameter having a load rating of approximately 1300 pounds. Further, the center hubs and the axles may run on a pair of bearings with a vertical shaft passing through the castor fork and hub which rotates on a pair of angular contact taper type bearings. This allows the castor wheels to handle a large load with minimal maintenance.

The use of the castor wheels has an important effect on the fundamental manner in which the front end skid steer loader is steered during it's operation. Under normal circumstances, a front end skid steer loader is controlled by limiting or stopping the rotation of the wheels on one side or the other of the loader. While this is an effective steering mechanism which allows for extremely tight vehicle turning radiuses, it also can be very destructive to the surface that the front end skid steer loader is operating on, especially when considering that both of the wheels on one side of the vehicle are often stationary while the wheels on the other side rotate around a central point between them. The result of this is that the stationary wheels forcibly tear up the surface of the ground and especially when that surface is composed of manicured grass.

The present invention's ability to remove the weight from the front end skid steer loader eliminates this surface destruction as only one of the stationary wheels is in contact with the ground. This moves the central pivot point to the center of that wheel which greatly reduces the portion of the front end skid steer loader that is stationary in relation to the ground during a turning maneuver which in turn eliminates the surface destruction normally caused in these types of vehicle operations. This allows a multitude of attachments to be used in conjunction with skid steers.

The present invention also employs the use of a pivotal attachment mechanism to attach an implement to the mount assembly. This is accomplished by the use of a central arm that extends forward from its pivotal point of attachment at the attachment plate. Additionally, the forward end of the central arm is connected to the body of the invention by the use of a floating elbow assembly which is used to position and control the orientation of the central arm. The floating assembly may take a variety of forms including the use of flexible linkage such as cables or chains or other types of mechanical or elbow assemblies including pin and slot type applications. The use of the floating type system allows for the lifting of implements while also allowing the implements to follow the ground contour and have their height varied in relation to the castor wheels in order to adjust for a variety of operating conditions.

For a better understanding of the present invention, reference should be made to the drawings and the description in which there are illustrated and described preferred embodiments of the present invention.

### DESCRIPTION OF THE DRAWINGS

FIG. 1 is a perspective view of a typical skid steer loader being shown as equipped with the present invention which is attached to the forward end of the loader's arms by the means of an OEM attachment plate.

FIG. 2 is a side elevation view of a typical skid steer loader having the present invention attached to the forward end of the loader's arm and illustrating the manner in which the loader's hydraulic system and the arms are used in conjunction with the invention to raise the loader's front wheels off of the surface of the ground to transfer the steering control exclusively to the rear wheels.

FIG. 3 is a perspective view of the present invention illustrating its manner of construction and the relative positions of its major components including the castor wheels, floating elbow, pivoting implement mount assembly, and implement attachment bracket.

FIG. 4 is a top elevation view of the present invention illustrating its general manner of construction and, specifically, the manner in which the pivoting implement mount assembly extends outward from its point of attachment on the OEM attachment plate.

FIG. 5 is a side elevation view of the present invention illustrating the general manner of construction of the floating elbow assembly and the way in which the implement attachment bracket is extended out in front of the castor wheels to hold a specific implement in a desired position.

FIG. 6 is a perspective view of the present invention's hydraulic system which illustrates the manner in which the hydraulic pressure that is necessary to operate the invention is distributed to its primary components.

### DESCRIPTION OF THE PREFERRED EMBODIMENT

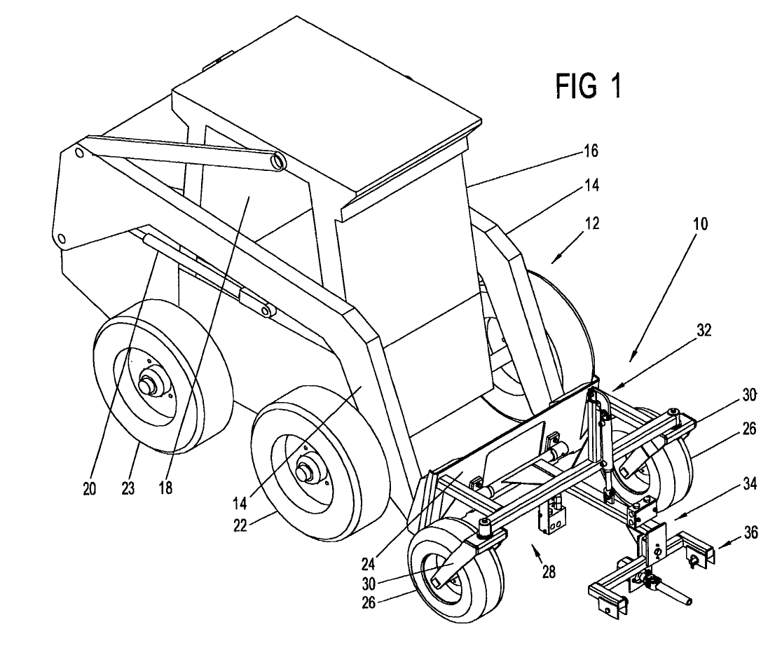

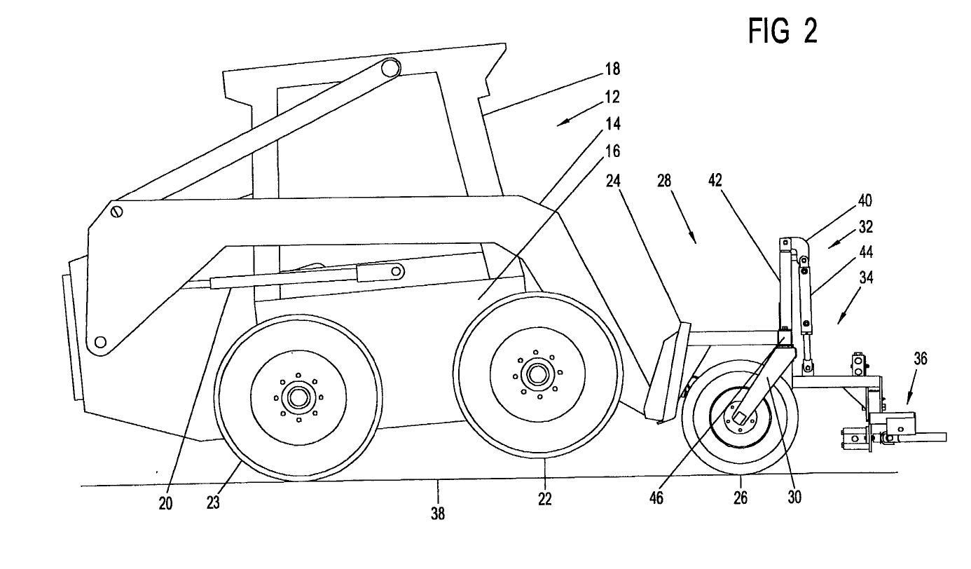

Referring now to the drawings, and more specifically to FIGS. 1 and 2, the zero turn radius front end loader implement attachment apparatus 10 is fixed to the forward portion of a typical front end skid steer loader 12. This attachment is accomplished by the use of an OEM apparatus attachment plate 24 that readily attaches to the forward end of the front end skid steer loader's 12 arms 14 which are in turn controlled through the use of the arm hydraulic cylinders 20 under the control of the operator. With the present invention thus attached, the hydraulic system of the front end skid steer loader 12 can be used to control the vertical orientation of any implements that are being used to accomplish a specific purpose.

A typical front end skid steer loader 12 has a pair of front skid steer wheels 22 and a pair of rear skid steer wheels 23 which are not only used to propel the vehicle but are also the primary components employed in its unconventional steering mechanism. This steering control of such vehicles is obtained by limiting or stopping the rotation of the front and rear skid steer wheels, 22 and 23, on one side of the front end skid steer loader 12. This action causes these wheels to drag which in turn causes the wheels on the opposite side to arch around the others, thus, changing the orientation of the front end skid steer loader 12 and the direction it is traveling. Additionally, the front end skid steer loader 12 is also equipped with a body 16 containing a cab 18 from which the operator controls all the functions associated with the operation of the vehicle and any implements attached to its forward arms 14 by the use of the present invention.

The present invention is fixed to the arms 14 of the front end skid steer loader 12 by the use of the OEM apparatus attachment plate 24 which provides the platform upon which the remaining components of the present invention are constructed.

There are two other general components of the invention the first of which is the wheel frame 28. The wheel frame 28 provides the point of attachment for the castor wheels 26 which are rotationally attached at the outside forward corners of the wheel frame 28 by the wheel frame pivot mounts 46 and the pivoting wheel brackets 30. The use of the castor wheels 26, which are free to rotate around their point of attachment to the wheel frame 28, allows the front end skid steer loader 12 and the present invention to change direction without any direct input to the castor wheels 26 themselves. This system promotes simplicity and economical operation as the castor wheels 26 will simply track in any direction that the invention and front end skid steer loader 12 are traveling.

The wheel frame 28 also provides the point of attachment for the floating elbow assembly 32 which is the component of the present invention used to control the orientation of any attached implements. The floating elbow assembly 32 consists primarily of the vertical elbow bracket 42, the floating elbow 40, and the elbow hydraulic cylinder 44. The vertical elbow bracket 42 serves as both a mounting point on the wheel frame 28 for the floating elbow assembly 32 and as one of the pivotal mounting points for the floating elbow 40 itself. At its opposite end, the floating elbow 40 is pivotally attached to the upper end of the elbow hydraulic cylinder 44 which is in turn attached at its lower end to the implement mount central arm 64 component of the pivoting implement mount assembly 34. The pivoting implement mount assembly 34 also serves as the mounting point for the implement attachment bracket 36 which in turn allows for the attachment of a plurality of implements that are designed for specific purposes.

Thus, the floating elbow assembly 32 serves to suspend the forward portion of the pivoting implement mount assembly 34 (the rear of which is pivotally attached to the OEM apparatus attachment plate 24) below the wheel frame 28. This allows the vertical location of the pivoting implement mount assembly 34 to be varied in relation to the surface over which the front end skid steer loader 12 is traveling. These adjustments are made by the activation of the elbow hydraulic cylinder 44 which, when expanded will force the forward portion of the pivoting implement mount assembly downward placing the attached implement in a position that is closer to the ground surface 38. Conversely, when the elbow hydraulic cylinder 44 is contracted, an attached implement will be pulled away from the ground surface 38. Additionally, the design of the floating elbow allows the floating elbow assembly to move up and down on its own to adjust for any irregularities or obstacles in the ground surface 38 that may be encountered during operation.

The illustration of FIG. 2 depicts the manner in which the hydraulic system of the front end skid steer loader 12 is used in conjunction with the present invention to lift its front skid steer wheels 22 off of the ground surface 38 during operations. This removes the steering impetus of the front end skid steer loader 12 from both the front and rear skid steer wheels, 22 and 23, and places it entirely on the rear skid steer wheels 23. The result of this transfer decreases the potential for the wheels to cause damage to the surface the vehicle is operating on as the front end skid steer loader 12 is turning around a point defined by the center of one wheel instead of the point defined by the central point between the front and rear skid steer wheels, 22 and 23, on one side of the front end skid steer loader 12. This is important in the vehicle's operation as the latter situation forces the stationary front and rear skid steer wheels, 22 and 23, to also rotate around that central point during a turning operation which tends to tear up the ground surface 38 upon which they are operating. Conversely, with the steering impetus placed solely in the rear skid steer wheel 23, a steering manuevre is accomplished through the use of only one wheel which places much less stress on the ground surface 38 doing much less damage.

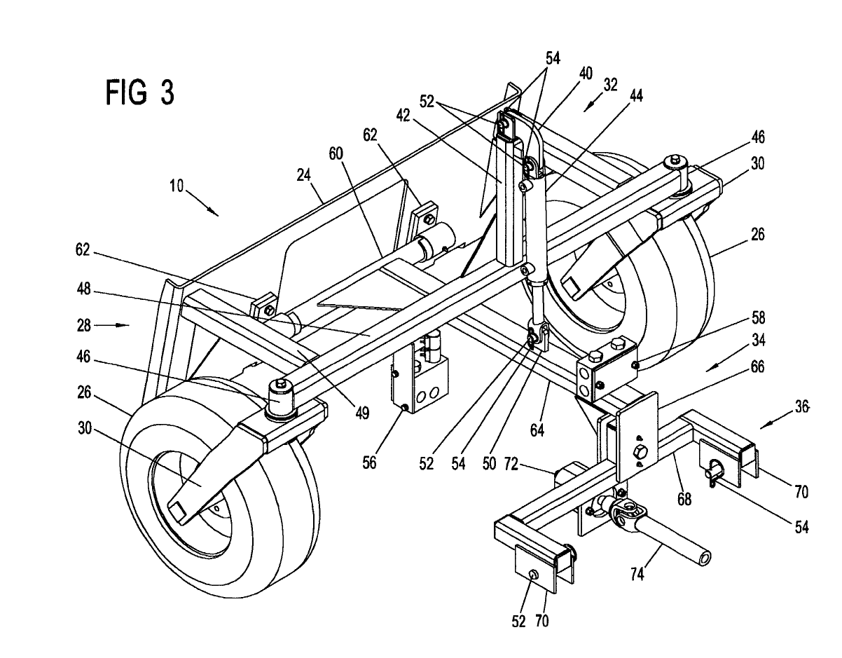

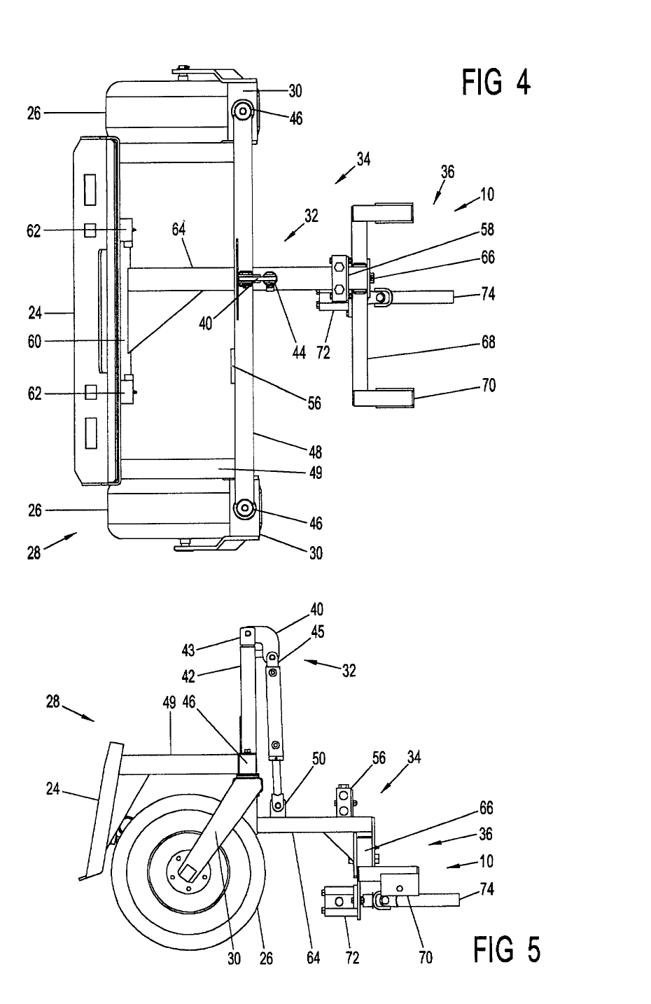

The manner of construction of the present invention is further illustrated in FIGS. 3, 4, and 5, which detail the nature of the relationships between the wheel frame 28, the pivoting implement mount assembly 34, and the implement attachment bracket 36. As previously stated, the wheel frame 28 provides the mounting point for the castor wheels 26 which serve to carry the weight of the front end skid steer loader 12 during operations. The wheel frame 28 is made up of the frame main rails 49 that extend forward from the OEM apparatus attachment plate 24 and terminate at the wheel frame pivot mounts 46. Spanning the gap between this terminus is the frame cross-member 48 which forms a rectangular box with the other components of the wheel frame 28 and the OEM apparatus attachment plate 24. The frame cross-member 48 also serves as the mounting point for the vertical elbow bracket 42 component of the floating elbow assembly 32 which is used to control and suspend the implement mount central arm 64 of the pivoting implement mount assembly 34 extending below it.

The pivoting implement mount assembly 34 is the component of the present invention that is used to position an attached implement in the desired location out front of the invention and to provide the vertical variability that is necessary to allow for the implement's positioning in relation to the surface upon which the vehicle is operating. The primary component of the pivoting implement mount assembly 34 is the implement mount central arm 64 which extends forward from its pivotal point of attachment at the OEM apparatus attachment plate 24 to the implement bracket plate 66 located at its most forward point. The attachment to the OEM apparatus attachment plate 24 is accomplished through the use of the pivot brackets 62 which are fixedly attached to the surface of the OEM apparatus attachment plate 24 and encircle the outer ends of the mount assembly pivot arm 60 which is the perpendicularly oriented mounting portion of the implement mount central arm 64. This pivotal method of attachment securely fastens the implement mount central mount 64 to the OEM apparatus attachment plate 24 while still allowing it to pivot freely.

As previously stated, the implement mount central arm 64 is attached to the wheel frame 28 through the floating elbow assembly 32. The floating elbow assembly 32 is made up of the vertical elbow bracket 42 which extends upward from the upper surface of the frame cross-member 48. The upper end of the vertical elbow bracket 42 is then pivotally attached to the upper end of the floating elbow 40 at the upper elbow mount 43. The lower end of the floating elbow 40 is then pivotally attached to the upper end of the elbow hydraulic cylinder 44 at the lower elbow mount 45. Finally, the lower end of the elbow hydraulic cylinder 44 is pivotally attached to the upper surface of the implement mount central arm 64 at the lower cylinder mount 50.

All of these pivotal attachments are accomplished by the use of a mount pin 52 which passes through corresponding holes in each of the components of the invention and is held there in place by the use of a retainer clip 54. This design not only facilitates the pivotal nature of the connections, but also allows for the quick and easy disassembly and assembly of these components which aids in invention repair and maintenance.

The floating elbow assembly 32 allows the operator of the front end skid steer loader 12 to control the vertical orientation of the pivoting implement mount assembly 34 through the elbow hydraulic cylinder 44. Additionally, the design of the elbow 40 and its attachment to the other components of the invention allow it to self adjust to any irregularities in the surface of the ground over which the front end skid steer loader 12 is traveling. This provides a degree of flexibility to the operation of the present invention that other designs cannot offer.

Finally, the most forward end of the implement mount central arm 64 provides the mounting point for the implement attachment bracket 36 at the implement bracket plate 66. The implement attachment bracket 36 is the component of the present invention which is used to attach the variety implements that are used in conjunction with a front end skid steer loader 12. The implement attachment bracket 36 is made up of a frame consisting primarily of the implement bracket cross-bar 68 which terminate at the connection brackets 70. The connection brackets 70 are the components that are employed to fasten the implement to the invention and employ the same mount pin 52 and retainer clip 54 system as used throughout the other similarly attached components of the invention.

The implement attachment bracket 36 also provides the mounting point for implement specific components such as the hydraulic motor 72 and PTO shaft 74 illustrated in these FIGS. These specific components may vary depending upon the implement being used and the implement attachment bracket 36 is designed be as versatile as possible. Thus, the present invention provides for the attachment of a variety of implements that allow a front end skid steer loader 12 to be used in a larger number of applications then was previously possible.

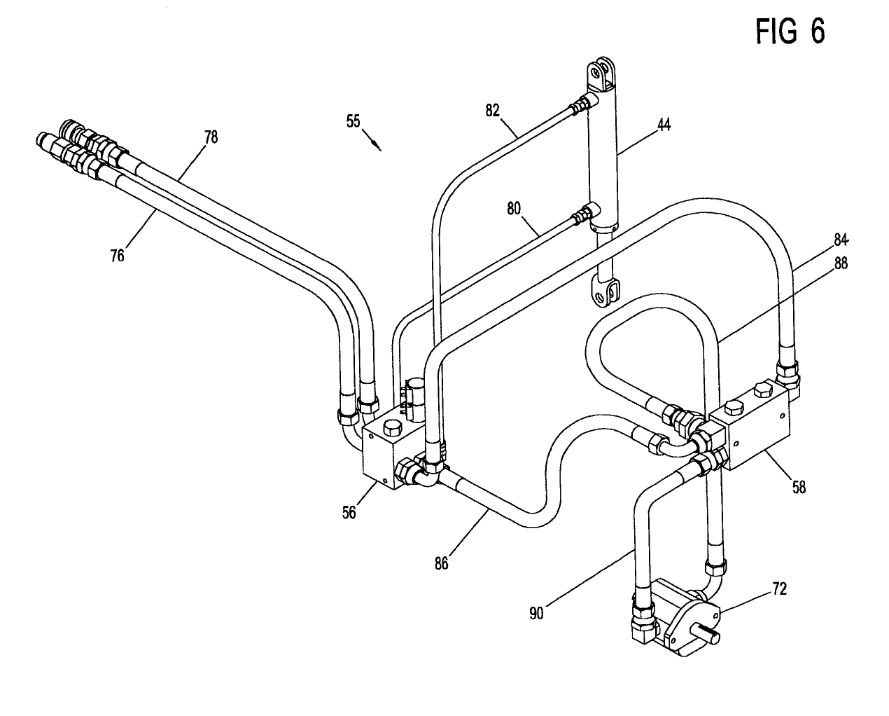

Finally, the manner of construction of the present invention's hydraulic system 55 is detailed in FIG. 6. The hydraulic system 55 of the invention makes use of the front end skid steer loader's 12 hydraulics which is transferred to the invention through the primary pressure line 78 to the primary hydraulic junction box 56 located on the lower surface of the frame cross-member 48. The primary hydraulic junction box 56 diverts the hydraulic pressure supplied by the front end skid steer loader 12 in two different manners. The first of these is through the floating elbow lift line 80 which carries the pressure to the elbow hydraulic cylinder 44 where it is used to control the orientation of the pivoting implement mount assembly 34. The spent hydraulic fluid is then returned to the primary hydraulic junction box 56 through the floating elbow lower line 82.

The second line of hydraulic pressure diversion at the primary hydraulic junction box 56 is through the connecting pressure line 86 to the secondary hydraulic junction box 58. The secondary hydraulic junction box 58 again diverts the hydraulic pressure to the specific implement components (in this case the hydraulic motor 72) through the implement pressure line 88. The spent hydraulic fluid from the implement component is returned first to the secondary hydraulic junction box 58 through the implement return line 90 and then to the primary hydraulic junction box 56 through the connection return line 84. From the primary hydraulic junction box 56 the hydraulic fluid is then returned to the front end skid steer loader 12 through the primary return line 76 thus completing the hydraulic system used to operate attached implements.

Although the present invention has been described in considerable detail with reference to certain preferred versions thereof, other versions are possible. For example, the type of tractor or implements used may vary greatly. Therefore, the spirit and scope of the appended claims should not be limited to the description of the preferred versions contained herein.

What is claimed is:

1. An attachment for the front end of a loader vehicle having loader arms said attachment comprising:
a loader attachment plate for attachment to said loader arms;
a frame system fixedly attached to said attachment plate;
a first and second castor wheel assembly pivotally mounted to said frame system; and
an implement mounting arm section pivotally attached to said loader attachment plate.

2. An attachment for the front end of a loader as in claim 1 further comprising a hydraulic lift cylinder attached to said implement mounting arm section so as to raise and lower said implement mounting arm section.

3. An attachment for the front end of a loader as in claim 2 further comprising a means of allowing said implement arm section to freely move vertically within defined limits.

4. An attachment for the front end of a loader as in claim 3 further comprising an implement attachment bracket attached to said implement mounting arm section.

5. An attachment for the front end of a loader as in claim 4 further comprising an implement drive mechanism attached to said implement mounting arm section.

6. An attachment for the front end of a loader as in claim 5 wherein said means of allowing said implement arm section to freely move vertically within defined limits is a bracket assembly connecting said hydraulic lift cylinder to said frame system.

7. A skid steer type loader and attachment frame comprising:
a skid steer type loader tractor having a pair of loader arms;
a loader attachment plate removably attached to said loader arms;
a frame system fixedly attached to said attachment plate;
a first and second castor wheel assembly pivotally mounted to said frame system; and
an implement mounting arm pivotally attached to said loader attachment plate.

8. A skid steer type loader and attachment frame as in claim 7 further comprising a hydraulic lift cylinder attached to said implement mounting arm so as to raise and lower said implement mounting arm.

9. A skid steer type loader and attachment frame as in claim 8 further comprising a means of allowing said implement arm to freely move vertically within defined limits.

10. A skid steer type loader and attachment frame as in claim 9 further comprising an implement attachment bracket attached to said implement mounting arm.

11. A skid steer type loader and attachment frame as in claim 10 further comprising an implement drive mechanism attached to said implement mounting arm.

12. A skid steer type loader and attachment frame as in claim 11 wherein said means of allowing said implement arm to freely move vertically within defined limits is a bracket assembly connecting said hydraulic lift cylinder to said frame system.
